(19) United States
(12) Patent Application Publication
(10) Pub. No.: US 2026/0273441 A1
(43) Pub. Date: Sep. 17, 2026

(54) Filter Element

(71) Applicant: HYDAC Filtertechnik GmbH, Sulzbach / Saar (DE)

(72) Inventors: Michael Sakraschinsky, St. Ingbert (DE); Stefan Hennes, Neunkirchen (DE); Dirk Röder, Saarbrücken (DE)

(73) Assignee: HYDAC Filtertechnik GmbH, Sulzbach / Saar (DE)

(21) Appl. No.: 18/872,139

(22) PCT Filed: Jun. 13, 2023
(86) PCT No.: PCT/EP2023/065830

§ 371 Date: Dec. 5, 2024

(30) Foreign Application Priority Data
Jun. 24, 2022 (DE) 10 2022 002 290.7

(51) Int. Cl. B01D 29/19

(52) U.S. Cl. CPC B01D 29/19; B01D 2201/291; B01D 2201/304

(57) ABSTRACT

Disclosed is a filter element with an element material which encloses a cavity, in particular in the form of a filtrate chamber, and which extends between two end caps which are arranged at the ends and which each have a sealing device, wherein one sealing device has a for example polygonal opening cross section and the other sealing device has a for example circular opening cross section, and one sealing device is part of a spherical bearing.

### CROSS-REFERENCE TO RELATED APPLICATIONS

This application claims priority to German Patent Application No. DE 10 2022 002 290.7, filed on Jun. 24, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter element with an element material which encloses a cavity, in particular in the form of a filtrate chamber, and which extends between two end caps which are arranged at the ends and which each have a sealing device.

DE 10 2018 009 187 A1 discloses a filter device with a filter housing and a filter element accommodated therein, the element material of which extends between two end caps, of which at least one end cap is mounted on an element holder by means of a spherical bearing which provides more than one degree of freedom so that the filter element is articulated on the element holder via its one end cap. This provides a compensation option for possible misalignment errors, so that a reduction of the narrow tolerance limits to be complied with for production is enabled, and thus filter devices even with long filter elements or with assembled filter housings can also be produced in an operationally reliable manner and at favourable manufacturing costs.

In this solution, in the operating position the filter element is fixed in a defined manner with its lower end cap via a screw thread, which forms a seal, in a housing-side holder and on its other, opposing end cap is guided by means of an O-sealing ring so as to be longitudinally movable along a nozzle-shaped element holder on the housing head of the filter housing.

Such filter devices together with their filter elements are sometimes subjected to very high stresses in harsh everyday operation, for example when such solutions are used as part of a hydraulic hammer operation where the filter element is regularly subjected to strong hydraulic pulsations. The fact that the one end of the filter element in the known solution is fixed stationarily in the housing via the thread means that the strong pulsations which occur, particularly during hammer operation, with the high differential forces on the filter element associated therewith can certainly damage it.

### SUMMARY

A need exists to provide a filter element that enables satisfactory operation even when the filter element is subjected to high stress, such as for example when hydraulic pressure pulsations occur.

The need is addressed by the subject matter of the independent claim(s). Embodiments of the invention are described in the dependent claims, the following description, and the drawings.

### BRIEF DESCRIPTION OF THE DRAWINGS

FIG. 1 shows a perspective view of a longitudinal section of an example filter device;

FIGS. 2, 3 show the top and bottom region, respectively, of the filter device of FIG. 1;

FIG. 4 shows an example spherical bearing arrangement of a filter element of FIGS. 1 and 2; and

FIG. 5 shows a perspective view of an example sealing device for the filter element in the region of the spherical bearing of FIGS. 1, 2 and 4.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the one sealing device has a for example polygonal, the other sealing device a for example circular opening cross-section, and the one sealing device is part of a spherical bearing. This provides that any misalignment errors that may occur can still be compensated via the spherical bearing and, furthermore, end caps “open” towards the inside are produced in this manner on the element via the free opening cross-sections of the respective sealing device which leads to a reduction in the pressure differential surfaces on the element, unlike in the known case where one end cap is open and the other end cap is closed. Due to the open end cap configuration, any forces occurring in the axial direction of the element are significantly minimised, so that failure-free operation is possible even when high stresses occur. This thus has no equivalent in prior art. The different opening cross-sections, for example on the one hand polygonal and on the other hand circular, prevent the possibility of incorrect installation when replacing an element with a new one, as there is only one plausible installation option and, furthermore, counterfeit protection is implemented, both of which benefit functionally reliable operation.

In some embodiments, it is provided that the two sealing devices each have an inner circumferential sealing surface which, viewed in a notional projection parallel to the longitudinal axis of the filter element, are congruent with each other. With the aforementioned configuration, a possible pressure differential surface is then further minimised, so that the forces occurring during operation cannot damage the filter element and in particular the element material at all.

In some embodiments, it is provided that the spherical bearing has two shell parts, of which one shell part is held stationary on the one end cap and the other shell part, which has the one sealing device, is held pivotably in the one shell part. In this way, even larger tolerance errors can be compensated and larger geometric variations from the one end cap to the other are possible, so that there is no longer any need to stringently adhere to very tight manufacturing tolerances which helps to reduce the manufacturing costs.

With the aforementioned configuration, it is for example provided that the one sealing device has an annular groove on the outer circumference into which the other shell part engages with an inner edge. In this way, a multi-part construction of spherical bearing is achieved with the one sealing device, so that in the event of failure of the aforementioned sealing device, it can readily and easily be replaced with a new seal.

In some embodiments, it is provided that the one polygonal sealing device forms a regular polygon, for example a square, on the inner circumference, that individual wall parts protrude convexly outwards with the same curvature between the corner points formed and rounded in this manner and that for example the largest curvature of one of the wall parts is smaller than the smallest curvature of one of the rounded corner points. In this way, the polygonal sealing device has an extremely inherently stable construction and, viewed in the radial transverse direction, is able to safely absorb forces, without being impaired in the sealing effect.

In this case, this one sealing device for example has a flat sealing surface on the inner circumference which opens out at the end along bevels when viewed towards the longitudinal axis of the filter element. In this manner, a defined, central sealing surface is generated, which performs the sealing without being overdetermined in the sealing effect by other components of the sealing device.

In some embodiments, the other sealing device is formed from an O-sealing ring, this O-sealing ring for example being encapsulated by sheet metal parts of the other end cap, in particular being enclosed except for an exposed sealing surface. Accordingly, both sealing devices are designed in such a manner that they can be guided so as to be longitudinally movable along guide parts, so that the element can be brought into a suitable, largely force-free position along the guide parts depending on adjustment of the pressure situation.

The disclosure further relates to a filter device for accommodating a filter element as presented above, a guide part with a cylindrical outer circumferential surface for the contact with the one sealing device being accommodated in one housing part of a filter housing, regularly in the form of a filter head, and a further guide part with cylindrical outer circumferential surface for the contact with the other sealing device being accommodated in a further housing part, regularly in the form of a filter bowl, which can be detachably connected to this housing part. In this way, inherently stable positioning of the filter element with relation to the housing parts of the filter device is achieved by means of the guide parts.

It is for example provided in this case that the one guide part is formed from a sleeve, along the outer side of which the one sealing device is guided so as to be longitudinally movable, and that the other guide part is formed from a cup-shaped insert which, in the form of a latching part, can be latched to the other housing part, and the outer circumference of which insert forms a longitudinal guide for the other sealing device. The aforementioned sleeve and the cup-shaped insert allow largely turbulence-free fluid flows for filtration with the filter element to be guided through the filter housing.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The drawings are schematic and not to scale.

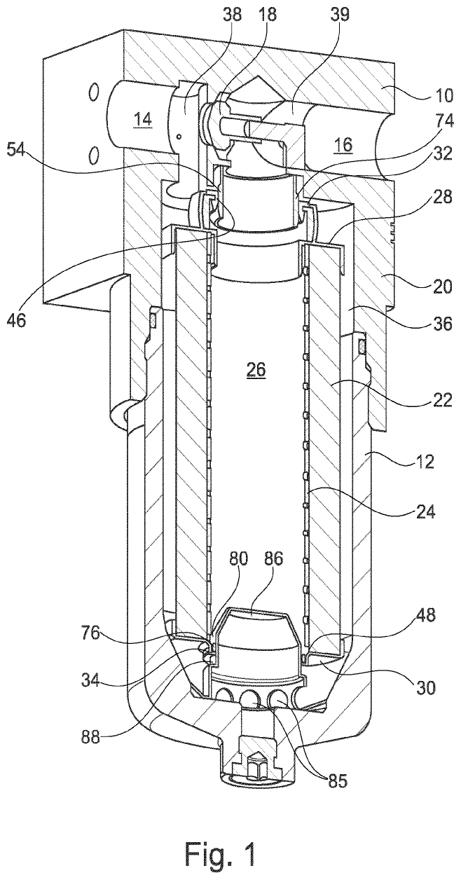

FIG. 1 shows a filter device as a whole in longitudinal sectional view. The filter device according to FIG. 1 has a filter head 10 and a filter bowl 12, which is detachably screwed to the filter head 10 in a known manner. The filter device according to FIG. 1 is shown in its usual, vertical operating position and the filter head 10 is connected to a hydraulic supply circuit (not shown) in a permanently fluid-conducting and stationary manner. Furthermore, the filter head 10 has an inlet 14 for an unfiltered medium flow and an outlet 16 for filtrate flow. Both the inlet 14 and the outlet 16 are connected in the usual manner to the said hydraulic supply circuit. A spring-loaded bypass valve 18, which opens in the event of a clogged or blocked filter element in the filter device, is connected between the inlet 14 and the outlet 16 and connects the inlet 14 directly to the outlet 16, bypassing the filter element, so that the fluid flow within the supply circuit is not interrupted. The aforementioned construction is common with such filter devices, with the result that it will not be discussed in greater detail at this point.

Both the filter head 10 and the filter bowl 12 form components of a filter housing 20 in which the filter element is accommodated. The filter element is usually provided with an element material 22 which is for example pleated to increase its filter surface. The element material 22 is supported on its inner side on a perforated supporting tube 24 and in this respect encloses a cavity 26, which in technical terms is also referred to as a filtrate chamber.

Furthermore, the element material extends between two end caps 28, 30, each of which has a sealing device 32, 34. The filter element accommodated in the filter device has a radial spacing from the inner circumferential side of the filter housing 20, so that the aforementioned inner circumferential side and the outer circumferential side of the filter element together define an unfiltered medium chamber 36 within the filter housing 20, which unfiltered medium chamber is connected in the direction of the filter head 10 to the inlet 14 via a channel-like fluid connection 38 in the filter head 10. The filtrate chamber 26, on the other hand, is connected to the outlet 16 for filtrate flow, the aforementioned further fluid connection 39 being routed past the bypass valve 18. Accordingly, the flow through the element material 22 is from outside to inside, viewed in the direction of FIG. 1, and any particle contamination located in the fluid flow is reliably cleaned off the element material 22.

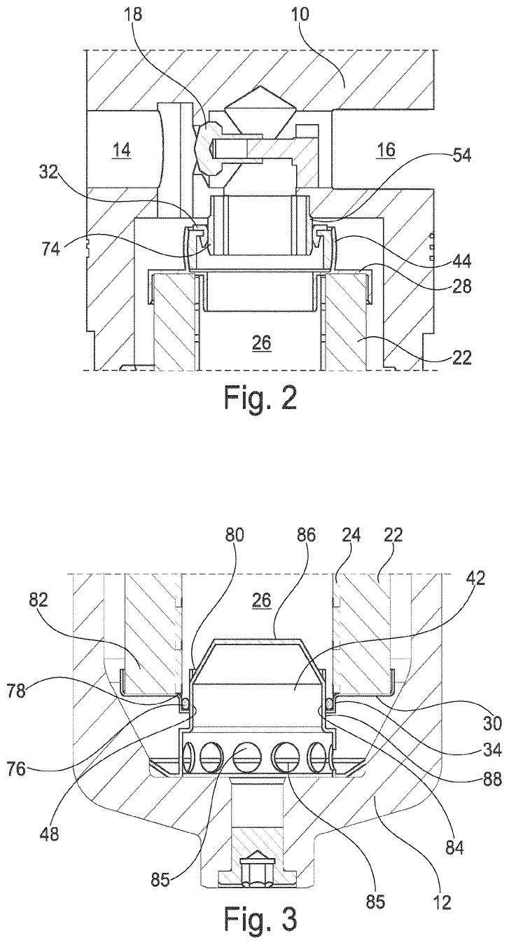

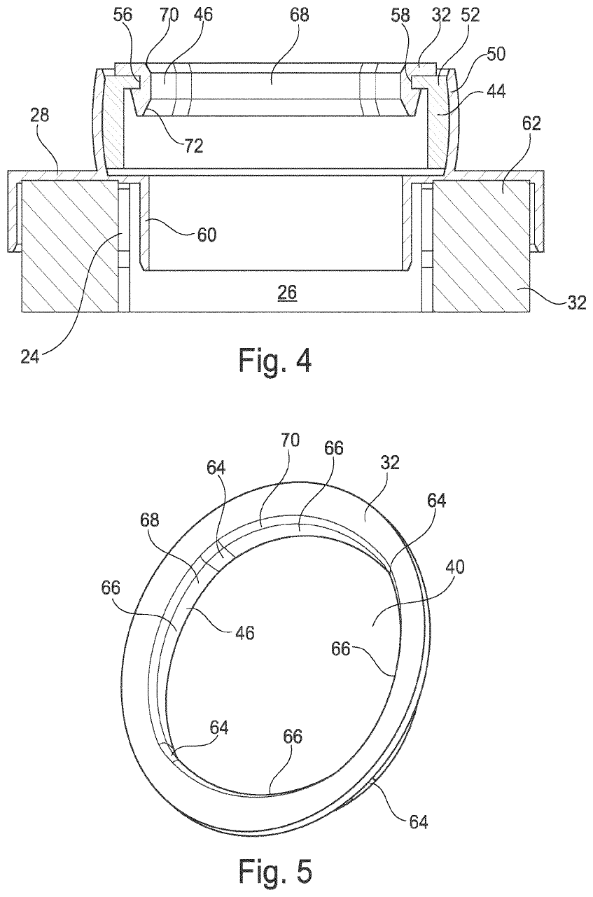

As FIG. 5 in particular shows, the one sealing device 32 is configured with a polygonal opening cross-section 40 and in particular according to the diagram of FIG. 3, the other sealing device 34 defines a circular opening cross-section 42. Furthermore, as FIG. 4 in particular shows, the one sealing device 32 is part of a spherical bearing 44 for the filter element with its element material 22. As can be seen from FIG. 1, the two sealing devices 32, 34 each have an inner circumferential sealing surface 46, 48 which, viewed in a notional cylindrical projection parallel to the longitudinal axis of the filter element, are congruent with each other. In this way, effective differential pressure surfaces are minimised and a force-free mounting of the filter element within the filter housing 20 of the filter device is largely achieved.

As can be seen from FIG. 4, the spherical bearing 44 has two shell parts 50, 52, of which one shell part 50 is held stationary on the one end cap 28, the other shell part 52, which has the one sealing device 32, being held pivotably in the one shell part 50. If the filter element with its spherical bearing 44 according to FIG. 4 is accommodated along a sleeve 54 in the filter head 10, as shown in greater detail in FIG. 2, the other shell part 52 is fixed in position with respect to the filter head 10, viewed in the radial direction, so that the one shell part 50 can slide in an articulated manner along the convex outer circumferential side of the other shell part 52 with more than one degree of freedom. In this respect, the convex outer circumferential surface of the other shell part 52 fits snugly against the correspondingly concave inner circumferential side of the one shell part 50. In this respect, the filter element with its filter material 22 is then pivotably arranged on the other shell part 52, viewed in various angular directions to the longitudinal axis of the filter element, and in this way can compensate any misalignment errors that may occur.

The one sealing device 32 has an annular groove 56 on its outer circumference into which the other shell part 52 engages with a protruding inner edge 58, according to the diagram of FIG. 4. The one-piece end cap 28 has a sleeve-shaped limiting wall 60 towards the bottom which protrudes into the filtrate chamber 26 with a predefinable overhang, namely with a predefinable radial distance to the inner circumferential side of the supporting tube 24 in this region. In this respect, the end cap 28 with its cylindrical outer edge and the inner limiting wall 60 forms a trough-shaped receiving space for an adhesive bed 62, not shown in greater detail, which is used to secure the end cap 28 to the free end-face ends of the element material 22 and the supporting tube 24.

As can further be seen from FIGS. 4 and 5, the one polygonal sealing device 32 forms a square on the inner circumference with four corner points 64, individual wall parts 66 protruding convexly outwards with the same curvature between the corner points 64 formed and rounded in this manner. The aforementioned sealing ring with polygonal opening cross-section has a substantially flat, annular sealing surface 68 on the inner circumference, formed by the corner points 64 and the wall parts 66, which opens out at the end along bevels 70, 72 as viewed towards the notional longitudinal axis of the filter element. By means of the bevels 70, 72, the actual sealing surface 68 is “cut free” and in this respect forms a sliding surface in a sealing manner for sliding along the outer circumferential side of the head-end sleeve 54, which can be seen in particular from the diagram of FIG. 2.

In this way, the upper end cap 28 is guided so as to be axially movable along the sleeve 54 via the spherical bearing 44 and the one sealing device 32 and is supported accordingly when viewed in the radial direction. In this respect, the sleeve 54 at least is accommodated stationary in a head-end recess as part of the further fluid guide 39 in the filter head 10. In this respect, the sleeve 54 forms a guide part 74, along the outer side of which the one sealing device 32 is guided so as to be longitudinally movable. The other sealing device, according to the diagram of FIG. 3, is formed from an elastomeric O-ring 76, which is encapsulated by sheet metal parts 78 of the other end cap 30, except for its inwardly exposed sealing surface 48. In this respect, the aforementioned other end cap 30 is formed from a shaped sheet metal part and in turn has a sleeve part 80 which protrudes towards the filtrate chamber 26 and which, with the annular outer wall of the end cap 30, serves in turn to accommodate a further adhesive bed 82 (not shown), with which the lower end regions of the element material 22 and the supporting tube 24 can be fixed to the other end cap 30 in a defined manner. In this lower end region of the filter element, there is also a further guide part 84 which is formed from a cup-shaped insert 86 which, designed as a latching part, is latched to the other housing part in the form of the filter bowl 12 on the base. The cup-shaped insert 86 again has a cylindrical, self-contained outer circumferential surface 88 on the outer circumference which forms a longitudinal guide with the O-sealing ring 76 for the other sealing device 34 shown. As can be seen accordingly from FIG. 1, on both opposing sides of the filter element, the latter is guided by means of the two sealing devices 32, 34 so as to be axially movable along the respective guide parts 74, 84, SO that the filter element can position itself independently in a self-supporting manner depending on the pressurising forces within the filter housing 20.

To prevent the oil draining away better when emptying the filter bowl 12, the further guide part 84 has circular cut-outs 85 on the base; however, since the bowl-like further guide part 84 is closed towards the filtrate chamber 26, no unfiltered medium can reach the filtrate side in this region, unless the unfiltered medium flows through the element material 22 of the filter element together with passing through the supporting tube 24 which is the usual filter operation.

The solution according to the teachings herein can also be readily used in the so-called hammer operation in which the filter element is subjected to high hydraulic stresses due to pulsations. The fact that there are two open end caps 28, 30 on the filter element makes it possible to significantly minimise the effective pressure differential surface and thus the force in the axial direction. For this purpose, both end caps 28, 30 must be reliably sealed which is readily possible using the aforementioned sealing devices 32, 34. Since the one sealing device 32 is clipped to the spherical bearing 44 of the one end cap 28 and the O-sealing ring 76 of the other sealing device 34 is guided in sheet metal parts 78 of the other end cap 30, the sealing devices 32, 34 do not need to be glued which makes the production of the filter element correspondingly easier and more cost-effective.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A filter element with an element material which encloses a cavity, and which extends between two end caps which are arranged at the ends and which each have a sealing device, wherein the one sealing device has a polygonal opening cross-section and the other sealing device has a circular opening cross-section, and wherein the one sealing device is part of a spherical bearing.

12. The filter element of claim 11, wherein the two sealing devices each have an inner circumferential sealing surface which, viewed in a notional projection parallel to the longitudinal axis of the filter element, are congruent with each other.

13. The filter element of claim 11, wherein the spherical bearing has two shell parts, of which one shell part is held stationary on the one end cap; and wherein the other shell part, which has the one sealing device, is held pivotably in the one shell part.

14. The filter element of claim 11, wherein the one sealing device has an annular groove on the outer circumference into which the other shell part engages with an inner edge.

15. The filter element of claim 11, wherein the one polygonal sealing device forms a regular polygon on the inner circumference; wherein individual wall parts protrude convexly outwards with the same curvature between the corner points formed and rounded in this manner.

16. The filter element of claim 11, wherein the one sealing device has a flat sealing surface on the inner circumference which opens out at the end along bevels when viewed towards the longitudinal axis of the filter element.

17. The filter element of claim 11, wherein the other sealing device is formed from an O-sealing ring.

18. The filter element of claim 11, wherein the -sealing ring is at least partially encapsulated by sheet metal parts of the other end cap.

19. The filter device for accommodating a filter element of claim 11, wherein a guide part with a cylindrical outer circumferential surface for the contact with the one sealing device is accommodated in one housing part of a filter housing and a further guide part with a cylindrical outer circumferential surface for the contact with the other sealing device is accommodated in a further housing part which can be detachably connected to this housing part.

20. The filter device of claim 19, wherein the one guide part is formed from a sleeve, along the outer side of which the one sealing device is guided so as to be longitudinally movable and in that the other guide part is formed from a cup-shaped insert which, in the form of a latching part, can be latched to the other housing part, and the outer circumferential surface of which insert forms a longitudinal guide for the other sealing device.

21. The filter element of claim 11, wherein the cavity is in the form of a filtrate chamber.

22. The filter device of claim 19, wherein the two sealing devices each have an inner circumferential sealing surface which, viewed in a notional projection parallel to the longitudinal axis of the filter element, are congruent with each other.

23. The filter device of claim 19, wherein the spherical bearing has two shell parts, of which one shell part is held stationary on the one end cap; and wherein the other shell part, which has the one sealing device, is held pivotably in the one shell part.

24. The filter device of claim 19, wherein the one sealing device has an annular groove on the outer circumference into which the other shell part engages with an inner edge.

25. The filter device of claim 19, wherein the one polygonal sealing device forms a regular polygon on the inner circumference; wherein individual wall parts protrude convexly outwards with the same curvature between the corner points formed and rounded in this manner.

26. The filter device of claim 19, wherein the one sealing device has a flat sealing surface on the inner circumference which opens out at the end along bevels when viewed towards the longitudinal axis of the filter element.

27. The filter device of claim 19, wherein the other sealing device is formed from an O-sealing ring.

28. The filter device of claim 19, wherein the O-sealing ring is at least partially encapsulated by sheet metal parts of the other end cap.

29. The filter element of claim 15, wherein the largest curvature of one of the wall parts is smaller than the smallest curvature of one of the rounded corner points.

30. The filter device of claim 25, wherein the largest curvature of one of the wall parts is smaller than the smallest curvature of one of the rounded corner points.
